(19) United States
(12) Patent Application Publication
(10) Pub. No.: US 2011/0083558 A1
(43) Pub. Date: Apr. 14, 2011

(54) APPARATUS FOR THE SEPARATION OF GAS AND SOLID AND/OR LIQUID CONTAMINANTS

(76) Inventor: Rick Van Der Vaart, Rijswijk (NL)

(21) Appl. No.: 12/865,598

(22) PCT Filed: Jan. 28, 2009
(86) PCT No.: PCT/EP09/50919

§ 371 Date: Dec. 8, 2010

(30) Foreign Application Priority Data
Jan. 30, 2008 (EP) 08101115.7

(51) Int. Cl. B01D 45/14; B01D 45/00

(52) U.S. Cl. 95/270; 55/445; 95/267

(57) ABSTRACT

Apparatus for the separation of gas and solid and/or liquid contaminants, comprising a housing with a gas inlet for contaminated gas at one end of the vessel, a separating body, a gas outlet for purified gas at the opposite end of the housing and a contaminants outlet downstream of the separating body, wherein the separating body comprises a plurality of ducts over a part of the length of the axis of the housing, which ducts have been mounted on a central axis of rotation, in which apparatus the separating body has been composed of a plurality of perforated discs wherein the perforations of the discs form the ducts.

The present invention relates to an apparatus for the separation of gas and solid and/or liquid contaminants. The apparatus comprises a housing with a gas inlet for contaminated gas at one end of the vessel, a separating body, a gas outlet for purified gas at the opposite end of the housing and a contaminants outlet downstream of the separating body, wherein the separating body comprises a plurality of ducts over a part of the length of the axis of the housing, which ducts have been arranged around a central axis of rotation.

Such an apparatus is known. In EP-B 286160 such an apparatus is disclosed. The apparatus has been designed such that the gas flow in the ducts is laminar. In order to keep the Reynolds number sufficiently low, the hydraulic diameter of the ducts has been adapted. A similar apparatus has been described in WO-A 2007/097621. However, in this specification the hydraulic diameter of the ducts are adapted such that the Reynolds number is sufficiently high to achieve a turbulent flow. Another document wherein a similar separator has been described is U.S. Pat. No. 5,667,543. Herein the separator comprises one or more separating bodies. Further, it is observed that the ducts are non-parallel to the axis of rotation, whereby the separating process is enhanced.

The known separating bodies can be manufactured in a variety of ways. In one specific embodiment of the separating body the ducts consist of corrugated material wrapped around a shaft or a pipe. The material can consist of paper, cardboard, foil, metal, plastic or ceramic. See e.g. NL 1026473.

It will be appreciated that this specific embodiment complicates the provision of ducts that are not parallel to the axis of rotation, when the ducts are wrapped around such central axis. Moreover, it is difficult to construct identical ducts in wrapping material around an axis of rotation. It is an object of the present invention to make the construction of the separating body easier and to facilitate the way to obtain ducts that are non-parallel to the central axis of rotation.

Accordingly, the present invention provides an apparatus for the separation of gas and solid and/or liquid contaminants, comprising a housing with a gas inlet for contaminated gas at one end of the vessel, a separating body, a gas outlet for purified gas at the opposite end of the housing and a contaminants outlet downstream of the separating body, wherein the separating body comprises a plurality of ducts over a part of the length of the axis of the housing, which ducts have been arranged around a central axis of rotation, in which apparatus the separating body has been composed of a plurality of perforated discs wherein the perforations of the discs form the ducts.

It will be appreciated that the discs can be easily created by drilling or cutting a plurality of perforations into the relatively thin discs. By attaching several discs to together these discs form a separating body. By aligning the perforations ducts are obtained.

It is now also very easy to attach the discs such that the perforations are not completely aligned. By varying the number and nature of the non-alignment of the perforations the resulting ducts can be given any desired shape. In such cases not only ducts are obtainable that are not completely parallel to the central axis of rotation, but also ducts that form a helix shape around the axis of rotation. So, in this way very easily the preferred embodiment of having non-parallel ducts can be obtained. Hence it is preferred that the perforations of the discs have been arranged such that the ducts are not parallel to the central axis of rotation or form a helix shape around the axis of rotation.

Further, it will be appreciated that it is relatively easy to increase or decrease the diameter of the perforations. Thereby the skilled person has an easy manner at his disposal to adapt the (hydraulic) diameter of the ducts, and thereby the Reynolds number, so that he can easy ascertain that the flow in the ducts is laminar or turbulent, just as he pleases. The use of these discs also enables the skilled person to vary the diameter of the duct along the axis of the housing. The varying diameter can be selected such that the separated liquid or solid contaminants that are collected against the wall of the duct will not clog up the duct completely, which would hamper the operation of the apparatus.

The skilled person is also now enabled to maximise the porosity of the separating body. The easy construction of the discs allows the skilled person to meticulously provide the disc with as many perforations as he likes. He may also select the shape of the perforations. These may have a circular cross-section, but also square, pentagon, hexagon, octagon or oval cross-sections are possible. He may therefore minimise the wall thickness of the separating body and the wall thicknesses of the ducts. He is able to select the wall thicknesses and the shape of the ducts such that the surface area that is contributed to the cross-section of the separating body by the walls is minimal. That means that the pressure drop over the separating body can be minimised.

The apparatus can have a small or large number of ducts. Just as explained in the prior art apparatuses the number of ducts suitably ranges from 100 to 1,000,000, preferably from 500 to 500,000. The diameter of the cross-section of the ducts can be varied in accordance with the amount of gas and amounts and nature, e.g., droplet size distribution, of contaminants and the desired contaminants removal efficiency. Suitably, the diameter is from 0.05 to 50 mm, preferably from 0.1 to 20 mm, and more preferably from 0.1 to 5 mm. By diameter is understood twice the radius in case of circular cross-sections or the largest diagonal in case of any other shape.

The size of the apparatus and in particular of the separating body may vary in accordance with the amount of gas to be treated. In EP-B 286 160 it is indicated that separating bodies with a peripheral diameter of 1 m and an axial length of 1.5 m are feasible. The separating body according to the present invention may suitably have a radial length ranging from 0.1 to 5 m, preferably from 0.2 to 2 m. The axial length ranges conveniently from 0.1 to 10 m, preferably, from 0.2 to 5 m.

The number of discs may also vary over a large number. It is possible to have only two discs if a simple separation is needed and/or when the perforations can be easily made. Other considerations may the whether parallel ducts are desired, or when a uniform diameter is wanted. Suitably the number of discs varies from 3 to 1000, preferably from 4 to 500, more preferably from 4 to 40. When more discs, are used the skilled person will find it easier to gradually vary the diameter of the ducts and/or to construct non-parallel ducts. Moreover, by increasing or decreasing the number of discs the skilled person may vary the duct length. So, when the conditions or the composition of the gas changes, the skilled person may adapt the duct length easily to provide the most optimal conditions for the apparatus of the present invention. The size of the discs is selected such that the radial diameter suitably ranges from 0.1 to 5 m, preferably from 0.2 to 2 m. The axial length of the discs may be varied in accordance with construction possibilities, desire for varying the shape etc. Suitably, the axial length of each disc ranges from 0.001 to 0.5 m, preferably from 0.002 to 0.2 m, more preferably from 0.005 to 0.1 m.

Although the discs may be manufactured from a variety of materials, including paper, cardboard, and foil, it is preferred to manufacture the discs from metal or ceramics. Metals discs have the advantage that they can be easily perforated and be combined to firm sturdy separating bodies. Dependent on the material that needs to be purified a suitable metal can be selected. For some applications carbon steel is suitable whereas for other applications, in particular when corrosive materials are to be separated, stainless steel may be preferred. Ceramics have the advantage that they can be extruded into the desired form such as in honeycomb structures with protruding ducts.

Typically, the ceramics precursor material is chosen to form a dense or low-porosity ceramic. Thereby the solid or liquid contaminants are forced to flow along the wall of the ducts and not, or hardly, through the ceramic material of the walls. Examples of ceramic materials are silica, alumina, zirconia, optionally with different types and concentrations of modifiers to adapt its physical and/or chemical properties to the gas and the contaminants.

The discs may be combined to a separating body in a variety of ways. The skilled person will appreciate that such may depend on the material from which the discs have been manufactured. A convenient manner is to attach the discs to a shaft that provides the axis of rotation. Suitable ways of combining the discs include clamping the discs together, but also gluing them or welding them together can be done. Alternatively, the discs may be stacked in a cylindrical sleeve. This sleeve may also at least partly replace the shaft. This could be convenient for extruded discs since no central opening for the shaft would be required. It is preferred to have metal discs that are welded together.

The apparatus according to the invention is suitably used in the separation of carbon dioxide and/or hydrogen sulphide from natural gas. Accordingly, the present invention also provides the use of an apparatus as described herein, wherein a natural gas comprising carbon dioxide and/or hydrogen sulphide, is passed into the housing, carbon dioxide and/or hydrogen sulphide is separated in the separating body that rotates at a velocity of from 100 to 3000 rpm, and purified natural gas is exiting from the apparatus. A similar process has been described in WO-A 2006/087332. The natural gas has suitably a temperature from −100 to −20° C. Further, the natural gas may have a pressure of 1 to 50 bar. These gas conditions can be conveniently achieved by subjecting natural gas as recovered from an underground well to one or more expanding means, such as Joule-Thomson valves or turbines. Due to the expansion and therefore, the cooling of the gas, carbon dioxide and/or hydrogen sulphide may condense, so that the droplets formed can be separated from the natural gas via the apparatus of the present invention.

The invention will be further illustrated by means of the following figures.

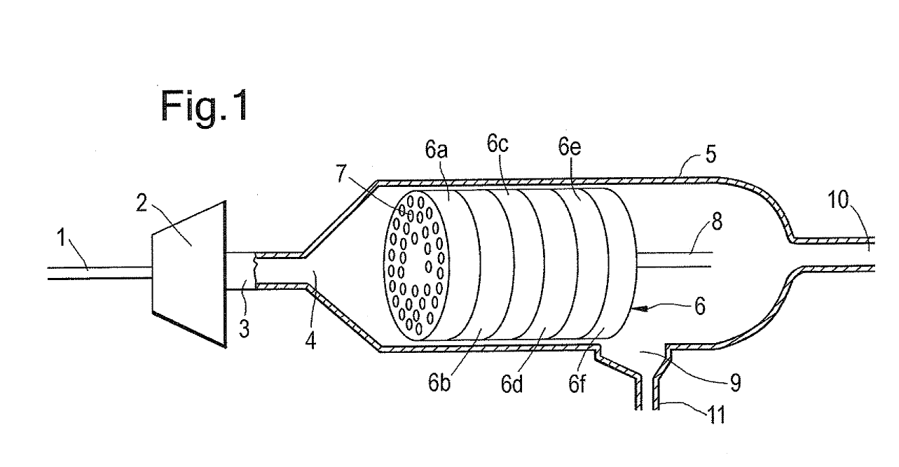

FIG. 1 shows schematically an apparatus for the separation of contaminants from a gas.

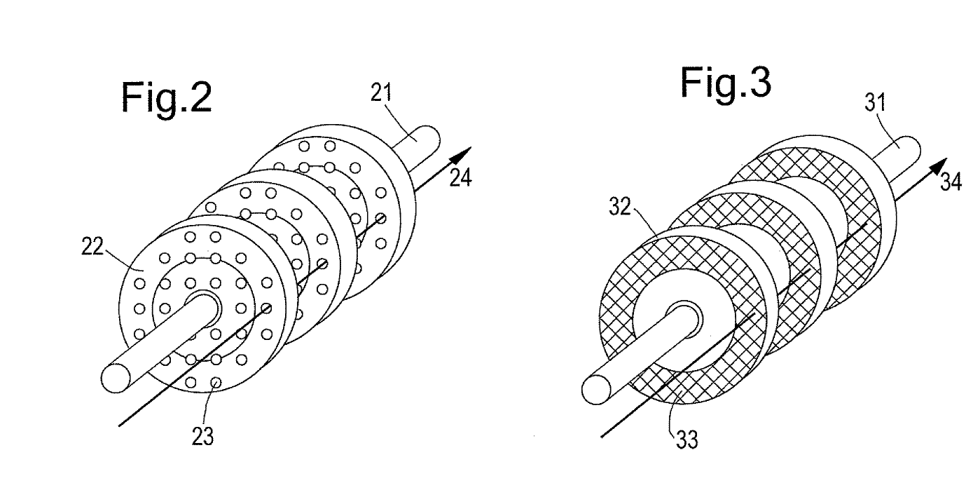

FIG. 2 shows schematically a few discs which can be combined into a separating body.

FIG. 3 shows an alternative embodiment of the discs shown in FIG. 2.

Referring to FIG. 1, natural gas via a conduit 1 is passed through an expansion means 2, whereby the gas is cooled. The cooled gas flows via a conduit 3 to a gas inlet 4 in a housing 5. The housing 5 further comprises a separating body 6 which shows a large number of ducts 7 which are arranged around a shaft 8, which provides an axis of rotation. Separating body 6 has been composed of six discs 6a, 6b, 6c, 6d, 6e and 6f that have been combined by welding or gluing. In the rotating separating body droplets of carbon dioxide and/or hydrogen sulphide are separated from the natural gas. The separated contaminants are discharged from the housing via a contaminants outlet 9 which has been arranged downstream of the separating body 6m, and via a discharge conduit 11. Purified natural gas leaves housing 5 via a gas outlet 10 arranged at the opposite end of the housing 5.

FIG. 2 shows a shaft 21 for incorporation in a housing. The figure further shows a plurality, in this case three, discs 22 with perforations 23. The perforations 13 have a circular cross-section. When the discs are to form a separating body the discs are combined, e.g., by gluing or welding them together. When they are combined the discs are arranged such that the perforations 23 are aligned in accordance with the arrow 24.

Another embodiment is shown in FIG. 3 where also three discs 32 are shown that have been mounted on a shaft 31. The discs 32 have been provided with substantially square perforations 33. As indicated above, other shapes, such as pentagon, hexagon, octagon or oval shapes, are also feasible. When the discs are combined the perforations are aligned along the arrow 34.

If ducts are desired that are non-parallel to the shafts 21 or 31, the perforations can be arranged such that the arrows 24 or 34 are not parallel to the shafts 21 and 31, respectively, but are at an angle with the respective shafts. In this way the benefits of the use of non-parallel ducts are attainable.

1. Apparatus for the separation of gas and solid and/or liquid contaminants, comprising:
a housing with a gas inlet for contaminated gas at one end of the housing, a separating body, a gas outlet for purified gas at the opposite end of the housing and a contaminants outlet downstream of the separating body,
wherein the separating body comprises a plurality of ducts over a part of the length of an axis of the housing, which ducts have been arranged around a central axis of rotation, in which apparatus the separating body comprises a plurality of perforated discs, wherein perforations of the discs form the ducts.

2. Apparatus as claimed in claim 1, wherein the number of ducts range from 100 to 1,000,000.

3. Apparatus as claimed in claim 1, wherein the number of discs ranges from 3 to 1000.

4. Apparatus as claimed in claim 1, wherein the perforations of the discs have been arranged such that the ducts are not parallel to the central axis of rotation.

5. Apparatus as claimed in claim 1, wherein the discs have been made from metal or ceramics.

6. (canceled)

7. (canceled)

8. (canceled)

9. A method of separating a gas from at least one of liquid and solid contaminants, comprising:
passing the gas and contaminants through a separating body in the housing, the separating body comprising a plurality of perforated discs; removing the gas from a gas outlet; and
removing the contaminants from a contaminant outlet.

10. The method of claim 9, further comprising spinning the discs at a velocity of from 100 to 3000 rpm.
